(19) United States
(12) Patent Application Publication
(10) Pub. No.: US 2026/0194773 A1
(43) Pub. Date: Jul. 9, 2026

(54) Liquid Crystal System and Lighting Device for a Vehicle

(71) Applicant: HELLA GMBH & CO. KGAA, Lippstadt (DE)

(72) Inventor: Martin Trinschek, Hamm (DE)

(21) Appl. No.: 19/441,063

(22) Filed: Jan. 6, 2026

(30) Foreign Application Priority Data
Jan. 8, 2025 (DE) 102025100396.3

(51) Int. Cl. G02F 1/133; F21S 41/64; F21S 43/00; G02F 1/13

(52) U.S. Cl. CPC G02F 1/13306; F21S 41/645; F21S 43/601; G02F 1/1309

(57) ABSTRACT

A liquid crystal system is provided. The liquid crystal system includes a liquid crystal element and drive electronics. The liquid crystal element has a front-side electrode with a front-side drive contact and a rear-side electrode with a rear-side drive contact. The drive electronics are configured to apply a front-side drive voltage to the front-side drive contact and a rear-side drive voltage to the rear-side drive contact. The liquid crystal element further includes a front-side test contact on the front electrode and a rear-side test contact on the rear electrode. The drive electronics are further configured to measure a front-side test voltage at the front-side test contact for comparison with the front-side drive voltage. The drive electronics are further configured to measure a rear-side test voltage at the rear-side test contact for comparison with the rear-side drive voltage. A lighting device for a vehicle is also provided.

### CROSS-REFERENCE TO RELATED APPLICATIONS

This application claims the benefit of German Patent Application 10-2025-100-396.3, filed Jan. 8, 2025, the disclosure of which is incorporated by reference in its entirety.

### BACKGROUND OF THE INVENTION

The present invention relates to a liquid crystal system including at least one liquid crystal element that has a front-side electrode with a front-side drive contact and a rear-side electrode with a rear-side drive contact, and drive electronics which are designed to apply a front-side drive voltage to the front-side drive contact of the respective liquid crystal element and to apply a rear-side drive voltage to the rear-side drive contact of the respective liquid crystal element. The present invention further relates to a lighting device for a vehicle, including at least one such liquid crystal system.

Liquid crystal systems of the type mentioned above are also referred to as LC systems and are used in a wide variety of areas, for example, as so-called LC displays for displaying information or as so-called smart glass with an electrically switchable light transmission. Such liquid crystal systems are also increasingly used in safety-relevant applications, for example, in lighting devices of vehicles.

### SUMMARY OF THE INVENTION

Against this background, the object of the present invention is based on the task of realizing malfunction detection in a liquid crystal system of the type mentioned above or a lighting device for a vehicle of the type mentioned above. This object is achieved by a liquid crystal system and by a lighting device for a vehicle with the features disclosed herein.

The liquid crystal system according to the invention comprises at least one liquid crystal element designed in a manner known from the prior art, with a front-side electrode and a rear-side electrode, between which a liquid crystal layer is arranged. Preferably, both electrodes are transparent, and each comprises a glass substrate coated to be electrically conductive. The front-side electrode has a front-side drive contact via which a front-side drive voltage can be applied to the front-side electrode, and the rear-side electrode has a rear-side drive contact via which a rear-side drive voltage can be applied to the rear-side electrode. In principle, it is also conceivable that the front-side electrode and/or the rear-side electrode has several drive contacts. Preferably, the liquid crystal system according to the invention comprises multiple individually controllable liquid crystal elements. In this context, it is conceivable both that the multiple liquid crystal elements each have a front-side electrode with a front-side drive contact and a rear-side electrode with a rear-side drive contact, and that multiple liquid crystal elements have a common front-side electrode or a common rear-side electrode. In so-called smart glass, for example, multiple liquid crystal elements often have a common large-area rear-side electrode.

The liquid crystal system according to the invention further comprises drive electronics which are designed in a manner known from the prior art to drive the at least one liquid crystal element, i.e., to optionally switch it to be transparent or opaque. In particular, the drive electronics are electrically connected to the front-side drive contact and the rear-side drive contact of the at least one liquid crystal element and are designed to apply a suitable front-side drive voltage to the front-side drive contact of the respective liquid crystal element and to apply a suitable rear-side drive voltage to the rear-side drive contact of the respective liquid crystal element in order to drive the at least one liquid crystal element. Typically, the drive electronics are designed to drive the front-side electrode and the rear-side electrode in opposite phase, i.e., to apply a positive front-side drive voltage to the front-side drive contact and a negative rear-side drive voltage to the rear-side drive contact, or vice versa, so that a square-wave alternating voltage is applied between the two electrodes. It is also conceivable that the front-side drive voltage or the rear-side drive voltage is not negative during one phase but is approximately equal to zero. Preferably, the drive electronics are designed as an integrated circuit. The drive electronics may be arranged separately from the at least one liquid crystal element on a separate circuit board and electrically connected to the at least one liquid crystal element via connection cables or other suitable connection means. However, the drive electronics may also be arranged on a glass substrate of a liquid crystal element, wherein the drive electronics are preferably designed in a so-called chip-on-glass design.

According to the invention, at least one liquid crystal element comprises a front-side test contact on the front-side electrode and a rear-side test contact on the rear-side electrode, wherein the test contacts are preferably arranged as far away as possible from the drive contact of the respective electrode. The front-side test contact and the rear-side test contact of the at least one liquid crystal element are electrically connected to the drive electronics, wherein the drive electronics are designed in accordance with the invention to measure a front-side test voltage present at the front-side test contact and to compare it with the front-side drive voltage of the respective liquid crystal element, and to measure a rear-side test voltage present at the rear-side test contact and to compare it with the rear-side drive voltage of the respective liquid crystal element. Under normal conditions, the drive voltages applied to the two electrodes via the drive contacts should be present across the entire electrode and thus also be present at the respective test contact, so that under normal conditions, the front-side test voltage should always be substantially equal to the front-side drive voltage and the rear-side test voltage should always be substantially equal to the rear-side drive voltage. However, if at least one of the two test voltages deviates significantly from the respective drive voltage, this is a clear indicator that there is a defect in the respective liquid crystal element and/or in the supply lines of the respective liquid crystal element.

The test contacts according to the invention and the comparison of the test voltages with the drive voltages according to the invention can therefore be used to realize reliable malfunction detection in a relatively simple way.

In a preferred embodiment, the front-side drive contact and the front-side test contact are arranged on opposite sides of the respective front-side electrode, and the rear-side drive contact and the rear-side test contact are arranged on opposite sides of the respective rear-side electrode, so that defects can be detected in a relatively large area of the respective electrode by comparing the test voltages present at the test contacts with the respective drive voltage. In the case of rectangular electrodes, the drive contact and the test contact are preferably arranged at opposite corners of the respective electrode.

Preferably, at least one liquid crystal element has at least one further front-side test contact on the front-side electrode and/or at least one further rear-side test contact on the rear-side electrode, and the drive electronics are designed to measure a further front-side test voltage present at the at least one further front-side test contact and to compare it with the front-side drive voltage of the respective liquid crystal element and/or to measure a further rear-side test voltage present at the at least one further rear-side test contact and to compare it with the rear-side drive voltage of the respective liquid crystal element. By providing at least one additional test contact, defects can be detected in a particularly large area of the respective electrode, and thus a particularly reliable malfunction detection can be realized. Preferably, the drive contact, the test contact, and the at least one further test contact are arranged as far apart as possible from each other on the respective electrode, for example, in the corners of a rectangular electrode.

In a preferred embodiment of the liquid crystal system according to the invention, each liquid crystal element has a front-side test contact and a rear-side test contact, so that the presence of a defect can be detected for each liquid crystal element.

However, particularly in the case of a high number of liquid crystal elements, it may also be expedient to monitor only individual, particularly relevant liquid crystal elements, so that in an alternative preferred embodiment of the liquid crystal system according to the invention at least one liquid crystal element is present, which has no front-side test contact and/or no rear-side test contact. For example, out of multiple liquid crystal elements that have a common rear-side electrode, only the front-side electrodes of individual liquid crystal elements may have a front-side test contact.

The lighting device for a vehicle according to the invention comprises at least one liquid crystal system according to the invention as described above. In principle, the lighting device according to the invention may be any lighting device for any vehicle, for example, a headlamp, a rear lamp, or a body lighting device for a motor vehicle or for a trailer.

Since the lighting device according to the invention comprises at least one liquid crystal system according to the invention, a reliable malfunction detection can be realized in a relatively simple manner for the reasons described above.

### BRIEF DESCRIPTION OF THE DRAWINGS

Exemplary embodiments of the present invention are described below with reference to the accompanying figures. In the figures:

FIG. 1 is a schematic representation of a first lighting device for a vehicle according to the invention, with a first liquid crystal system according to the invention;

FIG. 2 is a schematic representation of a second lighting device for a vehicle according to the invention, with a second liquid crystal system according to the invention;

FIG. 3 is a schematic representation of a third lighting device for a vehicle according to the invention, with a third liquid crystal system according to the invention; and

FIG. 4 is a schematic representation of a fourth lighting device for a vehicle according to the invention, with a fourth liquid crystal system according to the invention.

### DETAILED DESCRIPTION OF THE CURRENT EMBODIMENTS

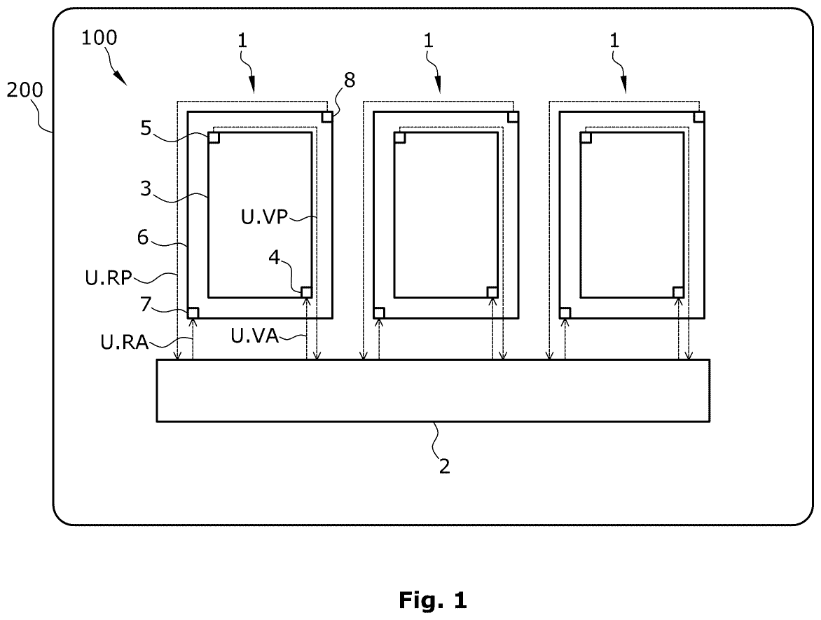

FIG. 1 shows a lighting device 200 according to the invention for a vehicle, which is not shown here.

The lighting device 200 comprises a liquid crystal system 100 according to the invention with three identical liquid crystal elements 1 and drive electronics 2, wherein, for reasons of clarity, only one of the liquid crystal elements 1 is provided with reference signs in full.

The liquid crystal elements 1 each comprise a front-side electrode 3 with a front-side drive contact 4 and a front-side test contact 5, wherein the front-side drive contact 4 and the front-side test contact 5 are arranged at opposite corners of the front-side electrode 3.

Furthermore, the liquid crystal elements 1 each comprise a rear-side electrode 6 with a rear-side drive contact 7 and a rear-side test contact 8, wherein the rear-side drive contact 7 and the rear-side test contact 8 are arranged at opposite corners of the rear-side electrode 6.

The drive electronics 2 are designed, for driving the liquid crystal elements (1), to apply a front-side drive voltage U. VA to the front-side drive contact 4 of the respective liquid crystal element 1 and to apply a rear-side drive voltage U. RA to the rear-side drive contact 7 of the respective liquid crystal element 1.

The drive electronics 2 are also designed to measure the front-side test voltages U. VP present at the front-side test contacts 5 of the liquid crystal elements 1 and to compare them with the front-side drive voltage U. VA of the respective liquid crystal element 1, and to measure the rear-side test voltages U. RP present at the rear-side test contacts 8 and to compare them with the rear-side drive voltage U. RA of the respective liquid crystal element 1.

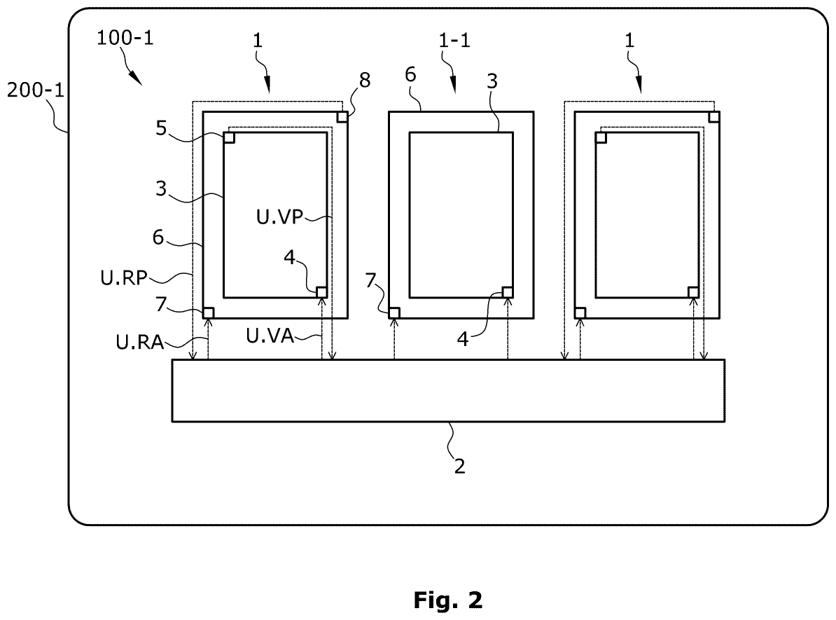

FIG. 2 shows a further lighting device 200-1 according to the invention, wherein the corresponding reference signs from FIG. 1 are used for features that are known to be identical or similar to the lighting device 200.

The lighting device 200-1 differs from the lighting device 200 in that the lighting device 200-1 comprises an alternative liquid crystal system 100-1 according to the invention, wherein the liquid crystal system 100-1 differs from the liquid crystal system 100 in that there is a liquid crystal element 1-1 which has a front-side drive contact 4 and a rear-side drive contact 7 for driving by the drive electronics 2, but has no front-side test contact 5 and no rear-side test contact 8.

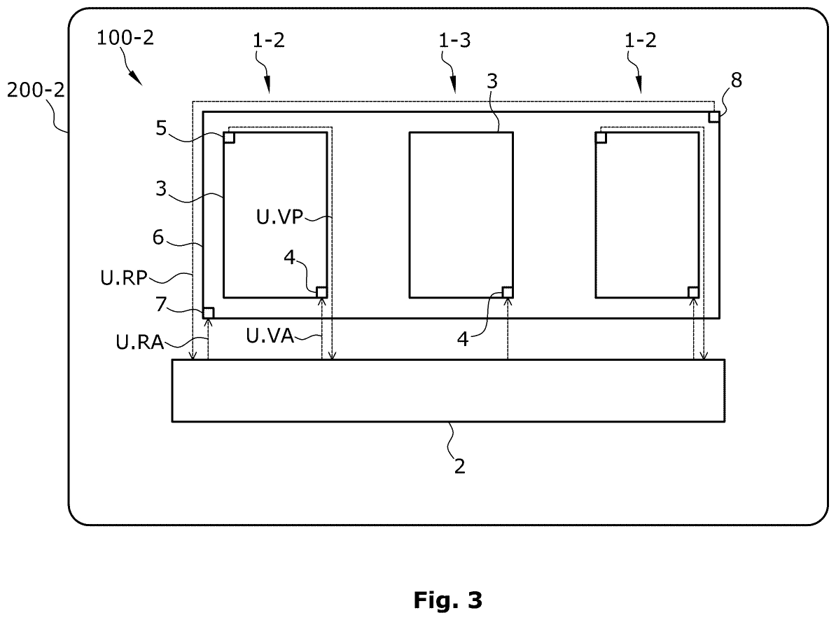

FIG. 3 shows a further lighting device 200-2 according to the invention, wherein the corresponding reference signs from FIG. 1 and/or FIG. 2 are used for features that are known to be identical or similar to the lighting device 200 or the lighting device 200-1.

The lighting device 200-2 differs from the lighting device 200-1 in that the lighting device 200-2 comprises an alternative liquid crystal system 100-2 according to the invention, wherein the liquid crystal system 100-2 differs from the liquid crystal system 100-1 in that the liquid crystal elements 1-2, 1-3 of the liquid crystal system 100-2 have a common rear-side electrode 6 in contrast to the liquid crystal elements 1, 1-1 of the liquid crystal system 100-1.

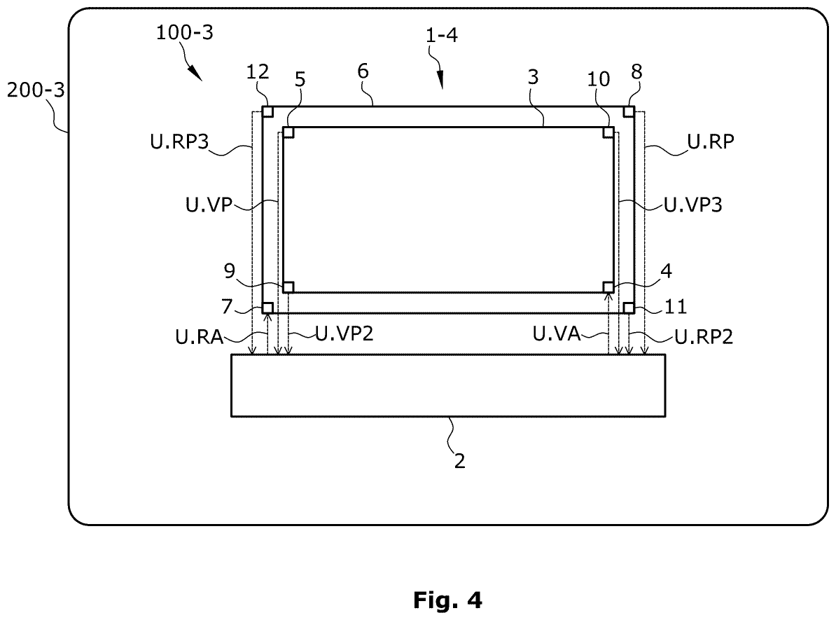

FIG. 4 shows a further lighting device 200-3 according to the invention, wherein the corresponding reference signs from FIG. 1, FIG. 2 and FIG. 3 are used for features which are known to be identical or similar to the lighting device 200, the lighting device 200-1, or the lighting device 200-2.

The lighting device 200-3 differs from the lighting device 200 in that the lighting device 200-3 comprises an alternative liquid crystal system 100-3 according to the invention, wherein the liquid crystal system 100-3 differs from the liquid crystal system 100 in that only a single liquid crystal element 1-4 is present.

The liquid crystal element 1-4 differs from the liquid crystal elements 1 of the liquid crystal system 100 in that the front-side electrode 3 has two further front-side test contacts 9, 10, which are arranged at the two corners of the front-side electrode 3 that are not occupied by the front-side drive contact 4 and the front-side test contact 5.

The liquid crystal element 1-4 also differs from the liquid crystal elements 1 of the liquid crystal system 100 in that the rear-side electrode 6 has two further rear-side test contacts 11, 12, which are arranged at the two corners of the rear-side electrode 6 that are not occupied by the rear-side drive contact 7 and the rear-side test contact 8.

The drive electronics 2 are designed to additionally measure further front-side test voltages U.VP2, U.VP3 present at the two further front-side test contacts 9, 10 and to compare each with the front-side drive voltage U.VA of the liquid crystal element 1-4, and to measure further rear-side test voltages U.RP2, U.RP3 present at the further rear-side test contacts 11, 12 and to compare each with the rear-side drive voltage U. RA of the liquid crystal element 1-4.

### LIST OF REFERENCE SIGNS

200; 200-1; 200-2; 200-3 lighting device
100; 100-1; 100-2; 100-3 liquid crystal system
1; 1-1; 1-2; 1-3; 1-4 liquid crystal element
2 drive electronics
3 front-side electrode
4 front-side drive contact
5 front-side test contact
6 rear-side electrode
7 rear-side drive contact
8 rear-side test contact
9, 10 further front-side test contacts
11, 12 further rear-side test contacts
U.RA rear-side drive voltage
U.RP rear-side test voltage
U.RP2, U.RP3 further rear-side test voltages
U.VA front-side drive voltage
U.VP front-side test voltage
U.VP2, U.VP3 further front-side test voltages

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A liquid crystal system, comprising:
a liquid crystal element, which has a front-side electrode with a front-side drive contact and a rear-side electrode with a rear-side drive contact; and
drive electronics for driving the liquid crystal element, the drive electronics being configured to apply a front-side voltage to the front-side drive contact and being configured to apply a rear-side voltage to the rear-side drive contact,
wherein the liquid crystal element includes a front-side test contact on the front-side electrode and includes a rear-side test contact on the rear-side electrode, and
wherein the drive electronics are configured to:
measure a front-side test voltage applied to the front-side test contact and to compare the front-side test voltage with the front-side drive voltage of the liquid crystal element, and
measure a rear-side test voltage applied to the rear-side test contact and to compare the rear-side test voltage with the rear-side drive voltage of the liquid crystal element.

2. The liquid crystal system of claim 1, wherein:
the front-side drive contact and the front-side test contact are arranged on opposite sides of the front-side electrode; and
the rear-side drive contact and the rear-side test contact are arranged on opposite sides of the rear-side electrode.

3. The liquid crystal system of claim 1, wherein:
the liquid crystal element further includes a further front-side test contact on the front-side electrode and a further rear-side test contact on the rear-side electrode; and
the drive electronics are further configured to:
measure a further front-side test voltage applied to the further front-side test contact and compare the further front-side test voltage with the front-side drive voltage of the liquid crystal element, and
measure a further rear-side test voltage applied to the further rear-side test contact and to compare the further rear-side test voltage with the rear-side drive voltage of the liquid crystal element.

4. The liquid crystal system of claim 1, wherein the liquid crystal element is one of a plurality of liquid crystal elements, wherein each of the plurality of liquid crystal elements has a front-side test contact and a rear-side test contact.

5. The liquid crystal system of claim 1, wherein the liquid crystal element is one of a plurality of liquid crystal elements, wherein at least one further liquid crystal element of the plurality of liquid crystal elements has no front-side test contact or rear-side test contact.

6. A lighting device for a vehicle, the lighting device comprising the liquid crystal system of claim 1.
